(19) United States
(12) Patent Application Publication
(10) Pub. No.: US 2026/0329633 A1
(43) Pub. Date: Oct. 22, 2026

(54) WORKFLOW MANAGEMENT SYSTEM WITH DATA PIPELINE SPECIFICATION BASED ON DATA-CENTRIC DIRECTED ACYCLIC GRAPH

(71) Applicant: Electronics and Telecommunications Research Institute, Daejeon (KR)

(72) Inventor: Siwoon SON, Daejeon (KR)

(73) Assignee: Electronics and Telecommunications Research Institute, Daejeon (KR)

(21) Appl. No.: 19/424,804

(22) Filed: Dec. 18, 2025

(30) Foreign Application Priority Data
Apr. 16, 2025 (KR) 10-2025-0049590

(51) Int. Cl. G06F 9/48

(52) U.S. Cl. CPC G06F 9/4881

(57) ABSTRACT

The present invention relates to a workflow management system (WMS) with a data pipeline specification based on a data-centric directed acyclic graph (DAG). A method of operating a WFS according to the present invention includes receiving the data pipeline specification defined based on the data-centric DAG; creating a data pipeline according to the data pipeline specification; and executing the data pipeline.

### CROSS-REFERENCE TO RELATED APPLICATION

This application claims priority to and the benefit of Korean Patent Application No. 10-2025-0049590, filed on Apr. 16, 2025, the disclosure of which is incorporated herein by reference in its entirety.

### BACKGROUND

### 1. Field of the Invention

The present invention relates to workflow technology and data orchestration technology.

### 2. Discussion of Related Art

A workflow management system (WMS) is used to automate complex workflows, manage inter-task dependencies, and optimize execution environments. Representative examples of the WMS include systems such as Argo Workflows, Apache Airflow, Prefect, and Kubeflow Pipelines. Most of these workflow management systems (hereinafter, WMSs) are designed to be task-centric based on a directed acyclic graph (DAG).

An existing task-centric DAG defines a dependency between tasks in a workflow and focuses on managing an execution order and parallelism of tasks. For example, in the Apache Airflow, dependencies may be defined in the DAG so that a task waits for results of a preceding task before being executed. However, the management and flow of the data are implicitly processed within the specification or referenced by code within the task, and explicit definitions of a status of the data or a movement of the data between storages is lacking.

Accordingly, existing task-centric DAG-based workflow designs suffer from the following major shortcomings:

### 1. Inefficiency in Data Management

In an existing workflow system, data flow and storage management are not explicitly defined, leading to the following problems:
Absence of data metadata: Metadata such as a data location (for example, storage path), a size (for example, file size), and a format (for example, CSV or JSON) is either omitted from the specification or implicitly processed. For example, when output data from task A is transferred to task B, data movement needs to be manually defined within the task if a path and format of the data are not specified.
Inefficiency of repetitive definitions: When the same data is used in several tasks, a data path and storage information need to be repeatedly defined in each task. For example, as shown in Table 1, repeatedly defining the same data path in several tasks complicates management and increases a likelihood of errors.

TABLE 1

```
tasks:
  - name: task1
  container:
    env:
      - name: INPUT_PATH
        value: “s3://bucket/input.csv”
  - name: task2
  container:
    env:
      - name: INPUT_PATH
        value: “s3://bucket/input.csv”
```

Inefficiency of container image management: In an existing workflow system, it is difficult to systematically manage registry host, image name, tag (i.e., version), and digest of a container image. In particular, container images need to be repeatedly specified within task definitions, and any change to image information requires the entire workflow to be modified, causing inefficiency.
Lack of data status management: There is lack of a structure capable of tracking status, such as data not being ready, data being processed, or whether an error occurs. This necessitates an additional coding task to ensure availability of data.

### 2. Complexity of Task Dependency Management

Defining an inter-task dependency in a task-centric DAG is a core of workflow design. However, when a data relationship is not specified, the following problems arise:
Difficulty in designing a data-centric workflow: The lack of an explicit structure for separately designing a data flow and a task dependency makes data-based workflow design difficult. For example, when data needs to be processed under specific conditions (for example, a size or format), code that links data between tasks increases in complexity.
Difficulty in debugging and maintenance: tracing data flow requires analyzing the code within tasks, making debugging and maintenance very complex in a large workflow. For example, when task A generates data and tasks B and C use the data, if data is incorrectly transferred, both code of task A and input definitions of tasks B and C need to be analyzed in a process of tracing such an error.

### 3. Lack of Versatility

The existing workflow system is dependent on specific workflow engines.
Lack of portability: A workflow specification is dependent on a syntax and structure of a specific engine, such as Argo Workflows or Apache Airflow. For example, since Argo Workflows uses a YAML Ain't Markup Language (YAML)-based specification, while Apache Airflow uses a Python-based script, reusing the same workflow in both engines requires rewriting the specification, which is cumbersome.
Environment dependency: Since a data storage path, an access scheme, and credentials are often hard-coded within tasks, the entire specification needs to be modified when any environment changes (for example, cloud storage changes). For example, when information required for data access is hard-coded as shown in Table 2, modification is inevitably needed when the information is changed by a cloud provider.

TABLE 2

```
env:
  - name: AWS_ACCESS_KEY
    value: “key1”
  - name: AWS_SECRET_KEY
    value: “secret1”
```

### 4. Repetitive Input Problem

Data and storage information are repeatedly input for each task, increasing the redundancy of the specification.
Increased redundancy: Since data paths and credentials need to be defined for each task, the specification becomes longer and more difficult to manage.
Increased error potential: When the same information is repeatedly defined for several tasks, a likelihood of inconsistencies or omissions increases.

### SUMMARY

The present invention is intended to address the shortcomings of existing technologies described above by designing a data-centric data pipeline that treats data as a core component of a workflow specification. Specifically, an object of the present invention is to present a data pipeline specification capable of enabling data to be treated as a first-class citizen and a status, location, and a relationship with a storage of the data to be explicitly managed.

Another object of the present invention is to provide a WMS that clearly defines data flow and task dependencies based on a data pipeline specification and reuses the same specification in various workflow engines.

Through this, the present invention is intended to not only systematically manage dependencies between data and tasks, but also minimize repetitive input to improve the versatility and efficiency of a workflow specification. The present invention is also intended to introduce a template scheme to provide a structure that enables the reuse of the same workflow in various environments simply by changing data, thereby reducing the complexity of managing large-scale data pipelines.

Additionally, the present invention is intended to manage container image information as a separate node to improve the reusability of image, and clearly define relationships with tasks to improve maintainability of specifications and enhance the scalability of large-scale workflows.

The present invention is not limited to the above-described objects, and other objects that are not mentioned will be clearly understood by those skilled in the art from the following description.

According to an aspect of the present invention, a method of operating a WMS includes: receiving a data pipeline specification defined based on a data-centric directed acyclic graph (DAG); creating a data pipeline based on the data pipeline specification; and executing the data pipeline.

According to an aspect of the present invention, a WMS includes a memory configured to store computer-readable instructions; and at least one processor configured to execute the instructions.

The at least one processor is configured to execute the instructions to read a data pipeline specification defined based on a data-centric DAG, create a data pipeline according to the data pipeline specification, and execute the data pipeline.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a configuration of a WMS according to an embodiment of the present invention;

FIG. 2 is a diagram illustrating a data pipeline specification according to an embodiment of the present invention; and

FIG. 3 is a flowchart illustrating an operation of the WMS according to an embodiment of the present invention.

### DETAILED DESCRIPTION

The present invention falls within the fields of a workflow management system (WMS) and data orchestration technology.

The present invention relates to a method and device for designing a data pipeline specification of a workflow based on a data-centric directed acyclic graph (hereinafter referred to as DAG) and defining data and storage in the specification, and the method and device may be universally applied to various workflow systems.

The data pipeline specification according to the present invention is designed based on a data-centric DAG and defines a data node, a storage node, a container image node, a task node, and relationships between the nodes. The data pipeline specification is extensible and reusable. The WMS 100 according to the present invention may systematically process data management and task execution based on the data pipeline specification.

The advantages and features of the present invention, and methods for achieving these will become apparent with reference to embodiments that will be described in detail below together with the accompanying drawings. However, the present invention is not limited to the embodiments that will be described hereinafter, but may be implemented in various different forms, the present embodiments are provided only to make the disclosure of the present invention complete and to fully inform those skilled in the art of the scope of the present invention, and the present invention is defined only by the claims. Meanwhile, the terms used herein are intended to describe the embodiments and are not intended to limit the present invention. In the present specification, singular forms include plural forms unless specifically stated otherwise. The terms “comprise” and/or “comprising” as used herein do not exclude the presence or addition of one or more other components, steps, operations, and/or elements in addition to mentioned components, steps, operations, and/or elements.

Although terms such as “first” and “second” are used to describe various components, the components should not be limited by such terms. The terms may be used to distinguish one component from another. For example, a first component may be referred to as a second component, and similarly, a second component may also be referred to as a first component without departing from the scope of the present invention.

When a component is referred to as being “connected” or “coupled” to another component, it should be understood that the component may be directly connected or coupled to the other component, but other intervening components may also be present in between. On the other hand, when a component is referred to as being “directly connected” or “directly coupled” to another component, it should be understood that there are no other intervening components. Other expressions that describe a relationship between components, such as “between” and “directly between” or “adjacent to” and “directly adjacent to” should also be construed similarly.

In describing the present invention, detailed description of related known technologies will be omitted when the description is deemed to unnecessarily obscure the gist of the present invention.

Hereinafter, embodiments of the present invention will be described in detail with reference to the accompanying drawings. To facilitate a comprehensive understanding of the present invention, the same means will be denoted by the same reference numerals regardless of the drawings.

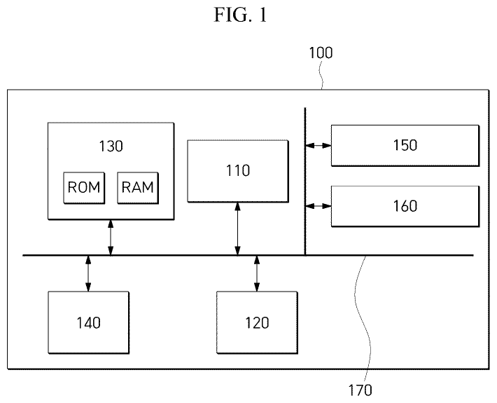

FIG. 1 is a block diagram illustrating a configuration of a WMS according to an embodiment of the present invention.

Referring to FIG. 1, the WMS 100 according to an embodiment of the present invention includes a processor 110, a communication device 120, a memory 130, a storage device 140, an input interface device 150, an output interface device 160, and a bus 170. The WMS 100 illustrated in FIG. 1 is an embodiment, and components of the WMS 100 according to the present invention are not limited to the embodiment illustrated in FIG. 1 and may be added, modified, or deleted as needed.

The processor 110 may be a central processing unit (CPU) or a semiconductor device that executes computer-readable instructions stored in the memory 130 or storage device 140. The memory 130 and the storage device 140 may include various types of volatile or nonvolatile storage media. For example, the memory 130 may include a read-only memory (ROM) and a random access memory (RAM). In embodiments of the present disclosure, the memory 130 may be located inside or outside the processor 110, and may be connected to the processor 110 via various known means. The memory 130 may be any type of volatile or nonvolatile storage medium, and for example, the memory 130 may include a ROM or a RAM.

Therefore, embodiments of the present disclosure may be implemented as a computer-implemented method or may be implemented as a non-transitory computer-readable medium in which computer-executable instructions are stored. In an embodiment, when the computer-readable instructions are executed by the processor 110, the computer-readable instructions may perform a method according to at least one aspect of the present disclosure.

The communication device 120 may transmit or receive wired or wireless signals.

Further, a method of operating the WMS 100 according to an embodiment of the present invention may be implemented in the form of program instructions that can be executed through various computer means and recorded on a computer-readable medium.

The computer-readable medium may include program instructions, data files, data structures, or the like alone or in combination. The program instructions recorded on the computer-readable medium may be those specially designed and configured for the embodiment of the present invention or may be those known and available to those skilled in the art of computer software. The computer-readable recording medium may include a hardware device configured to store and execute the program instructions. Examples of the computer-readable recording medium include a magnetic medium such as a hard disk, a floppy disk, and a magnetic tape, an optical medium such as a CD-ROM and a DVD, a magneto-optical medium such as a floptical disk, a ROM, a RAM, and a flash memory. Examples of the program instructions include not only machine language codes such as those created by a compiler, but also high-level language codes that can be executed through an interpreter or the like by a computer.

The processor 110 executes the method of operating the WMS by executing the computer-readable instructions stored in the memory 130 or the storage device 140.

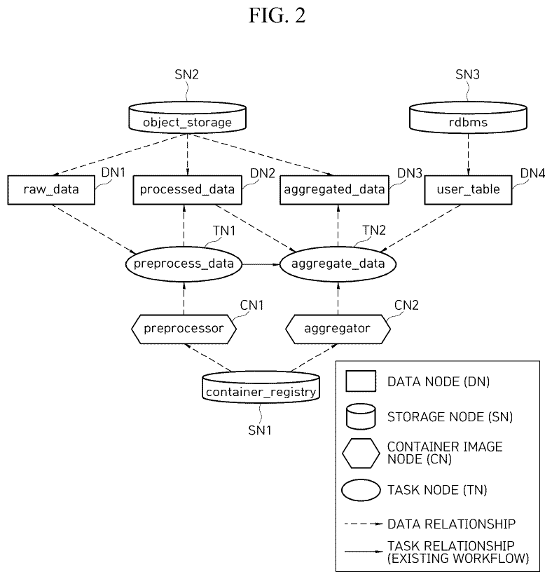

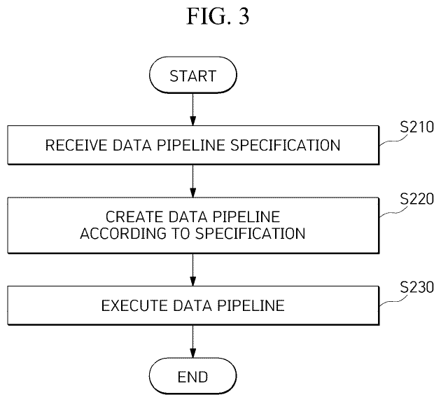

Hereinafter, a data pipeline specification according to an embodiment of the present invention will be described with reference to FIG. 2, and an embodiment of a method of operating the WMS 100 according to the data pipeline specification will be described with reference to FIG. 3.

FIG. 2 is a diagram illustrating the data pipeline specification according to the embodiment of the present invention. The WMS 100 receives the data pipeline specification from the communication device 120 or the input interface device 150 and stores the data pipeline specification in the storage device 140. The processor 110 of the WMS 100 uses the data pipeline specification to create and execute a data pipeline (workflow).

The data pipeline specification illustrated in FIG. 2 is represented as a data-centric DAG. In the graph of FIG. 2, nodes represent components, and edges represent relationships (dependencies) between components. In the field of workflow technology, a data pipeline (which may be referred to as a “workflow”) is typically defined as a DAG. Unlike existing technologies, the present invention not only represents task dependencies between task nodes as task relationships, but also represents data dependencies between the nodes as data relationships.

The data pipeline specification may be implemented as a data-centric DAG or may be converted into the data-centric DAG. For example, a user may define the data pipeline specification in the form of the data-centric DAG in the WMS 100 through a graphical user interface. As another example, the user may input a document or source code representing the data pipeline specification to the WMS 100 via the communication device 120 or the input interface device 150, and the WMS 100 may convert the document (for example, JSON or YAML) or source code (for example, Python) into data-centric DAG data or represent the document or the source code as the data-centric DAG.

Node types included in the data pipeline specification according to the present invention include a data node DN, a storage node SN, a container image node CN, and a task node TN. The data node DN represents data, the storage node SN represents storage, the container image node CN represents a container image, and the task node TN represents a task.

As illustrated in FIG. 2, the data nodes DN include a raw data node DN1, a processed data node DN2, an aggregation data node DN3, and a user table data node DN4. The storage nodes SN include a container registry storage node SN1, an object storage node SN2, and an RDBMS storage node SN3. Further, the container image nodes CN include a preprocessor container image node CN1 and an aggregation container image node CN2. The task nodes TN include a data preprocessing task node TN1 and a data aggregation task node TN2.

From FIG. 2, relationships (dependencies) between the data node DN, the storage node SN, the container image node CN, and the task node TN can be ascertained.

In the field of workflow technology, the dependency is an attribute that requires a specific state of another component when a certain component operates. Typically, the dependency is a task dependency, and when an execution order of a plurality of task nodes TN is specified, the involved task nodes TN have a task dependency. For example, when the data pipeline specification specifies a condition that task A needs to end before task B is executed, the task node TN responsible for task B is dependent on the task node TN responsible for task A.

Unlike existing technologies, the present invention proposes introducing the “data dependency” as well as the task dependency into the data pipeline specification. In the present specification, the data dependency refers to a precedence relationship regarding a data flow between the nodes.

Table 3 shows combinations of nodes with data dependencies and details of the data dependencies in the data pipeline specification according to the present invention.

TABLE 3

| Node combination with data | |
|---|---|
| dependency | Details of dependency |
| Data node DN and task node TN | Data input/output |
| Data node DN and storage node SN | Data storage/management |
| Task node TN and container image | Container image is needed |
| node CN | for execution of task node |
| Container image node CN and | Container image is stored and |
| storage node SN | managed in container registry |
| | storage node |

A data flow between the task nodes TN is defined based on data dependency between the data node DN and the task node TN. The task node TN manages a data flow between an input data node DN-In and an output data node DN-Out. The input data node DN-In and the output data node DN-Out are data nodes DN.

Further, each data node DN is connected to the storage node SN. Since the data node DN needs to be stored and managed in a specific storage node SN, the data node DN is dependent on the storage node SN.

When the task node TN operates as a container, a container image for executing the task node TN is necessarily needed. In this case, since the task node TN fetches the container image from the container registry storage node SN1 and executes the container image, the task node TN operating as a container is dependent on the container image node CN. Since the container image needs to be stored and managed in the container registry storage node SN1, the container image node CN is dependent on the storage node SN.

In FIG. 2, data relationships representing data dependencies between the nodes are indicated by dotted arrows, and task relationships (execution order relationships) representing task dependencies between the task nodes TN are indicated by solid arrows.

Hereinafter, details of the data pipeline specification according to the present invention will be described based on the node type.

### Data Node DN

The data node DN is a core component representing a state, location, format, and dependencies of data in the data pipeline specification according to the present invention. The data node may have various forms, such as a file, database table, and data stream.

Table 4 shows an example of attributes of the data node DN included in the data pipeline specification. The storage attributes presented in Table 4 represent data dependencies between the data node DN and the storage node SN. The data node DN may have other attributes in addition to those presented in Table 4.

TABLE 4

| Attributes | | |
|---|---|---|
| of data node | | |
| (DN) | Definition | Example |
| Node name | A unique identifier of the | |
| | data node DN | |
| Storage | Reference to the storage | |
| | node SN where the data | |
| | node DN stores or fetches | |
| | data | |
| Path | A path indicating a position | File data: file path |
| | in which data is stored, | (example: |
| | which is referred to as | data/raw_data.csv) |
| | “position” | Database data: table name |
| | | (example: users), query |
| | | (example: SELECT * |
| | | FROM orders) |
| Status | A status in which data is | Pending: data is not ready |
| | ready | (example: uploading) |
| | | Ready: data is ready |
| | | (example: uploading |
| | | completion) |
| | | Error: occurrence of error |
| | | during data creation or |
| | | access |
| Metadata | Additional information of | Size: size of data (example: |
| | data | 1024 MB) |
| | ※ Sub-attribute: size, | Format: data format |
| | format, and creation time | (example: CSV, JSON, |
| | (Created_at) | Parquet) |
| | | Creation time |
| | | (Created_at): data creation |
| | | or update time |

Table 5 shows an example of a data node specification constructed based on the attributes of the data node DN in Table 4. The data node specification is included in the data pipeline specification.

TABLE 5

```
dataNodes:
  - name: raw_data
    storage: object_storage
    path: “raw/raw_data.csv”
    status: “ready”
    metadata:
      size: “1024MB”
      format: “CSV”
      created_at: “2024-12-01T12:00:00”
  - name: user_table
    storage: rdbms
    query: “SELECT * FROM users”
    status: “ready”
    metadata:
      rows: “10000”
      created_at: “2024-12-01T11:30:00”
  - name: processed_data
    storage: object_storage
    path: “processed/processed_data.csv”
    status: “pending”
  - name: aggregated_output_data
    storage: object_storage
    path: “aggregated/aggregated_output.csv”
    status: “pending”
```

### Storage Node SN

The storage node SN is a node that manages information on a physical or logical storage for storing or fetching data and supports various types of storage.

Table 6 shows an example of attributes of the storage node SN included in the data pipeline specification. The storage node SN may have other attributes in addition to those presented in Table 6.

TABLE 6

| Attribute | | |
|---|---|---|
| of storage | | |
| node SN | Definition | Example |
| Node same | Unique identifier of | |
| | storage node SN | |
| Storage type | Type of storage | Object storage |
| | corresponding to storage | Relational database |
| | node SN | management system |
| | | (RDBMS) |
| Endpoint | Storage access path | |
| | (example: URL) | |
| Bucket name | Name of bucket in which | |
| | data is stored in object | |
| | storage | |
| Credentials | ※ Sub-attribute: | Credentials used by |
| | access key (access_key), | object storage: access_key |
| | secret key (secret_key), | and secret_key |
| | user name (username), and | Credentials used by |
| | password (password) | container registry storage |
| | | or RDBMS: username, |
| | | and password |

The storage node SN may have various storage types, and examples thereof are shown in Table 7.

TABLE 7

| Storage type | Description | Example |
|---|---|---|
| Object storage | Attributes of the storage | AWS S3, Ceph, |
| | node SN include a bucket | and MinIO |
| | name and an endpoint | |
| Relational database | The attributes of the | MySQL, PostgreSQL, |
| management system | storage node SN include | and Oracle |
| (RDBMS) | at least one of a database | |
| | name, a table name, and a | |
| | query | |
| NoSQL storage | The attributes of the | MongoDB and |
| | storage node SN include a | DynamoDB |
| | collection name and a | |
| | query | |
| File system | The endpoint attributes | NFS and HDFS |
| | include an absolute path | |
| | or a relative path of files | |
| Container registry | A type of storage that | Docker Hub |
| | stores container images | and Harbor |

Table 8 shows an example of a storage node specification constructed based on the attributes of the storage node SN presented in Tables 6 and 7. The storage node specification is included in the data pipeline specification.

TABLE 8

```
storageNodes:
  - name: object_storage
    type: object_storage
    endpoint: “OBJECT_STORAGE_URL”
    bucketName: “data_bucket”
    credentials:
      access_key: “ACCESS_KEY”
      secret_key: “SECRET_KEY”
  - name: rdbms
    type: rdbms
    endpoint: “http://database.example.com:5432”
    database: “example_db”
    credentials:
      username: “db_user”
      password: “db_password”
  - name: container_registry
    type: container_registry
    endpoint: “http://registry.example.com:5000”
    credentials:
      username: “registry_user”
      password: “registry_pass”
```

### Container Image Node CN

As described above, the container image node CN is a node representing the container image and is referenced by the task node TN. The container image node CN explicitly manages a version, storage information, and build information of the container image. Through the container image node CN, a large number of task nodes TN may reuse the same container image, and a specific task node TN may define the container image again when necessary.

Table 9 shows examples of the attributes of the container image node CN included in the data pipeline specification. The container image node CN may have other attributes in addition to those presented in Table 9.

TABLE 9

| Attributes of | |
|---|---|
| container image | |
| node CN | Definition |
| Node name | Unique identifier of container image node CN |
| Registry | Reference to storage node SN that stores |
| | container image |
| | Alternatively, a direct definition is also possible |
| Repository | Path in which container images are stored |
| Tag | Image version |
| Command | Basic commands required for task execution |
| Arguments | Arguments transferred upon command |
| | execution |
| Environment | Environment variables required by container |
| variables | image |
| Build info | Image creation information (image size, |
| | creation time, commit hash, and the like) |

Table 10 shows an example of the container image node specification constructed based on the attributes of the container image node CN in Table 9. The container image node specification is included in the data pipeline specification.

TABLE 10

```
imageNodes:
  - name: preprocessor
    registry Node: container_registry
    repository: “example.com/data-preprocessor”
    tag: “latest”
    command: [“python3”]
    args: [“main.py”]
    env:
      - name: INPUT_PATH
        value: “ ”
      - name: OUTPUT_PATH
        value: “ ”
    build_info:
    size: “100MB”
    created_at: “2024-12-01T10:00:00”
    commit_hash: “abcd1234”
  - name: aggregator
    registryNode: container_registry
    repository: “example.com/data-aggregator”
    tag: “latest”
    command: [“python3”]
    args: [“main.py”]
    env:
      - name: INPUT_01_PATH
        value: “ ”
      - name: INPUT_02_PATH
        value: “ ”
      - name: OUTPUT_PATH
        value: “ ”
    build info:
    size: “50MB”
    created_at: “2024-12-01T10:00:00”
    commit_hash: “abcd1234”
```

### Task Node TN

The task node TN defines a task that is executed within the data pipeline, interacts with the data node DN, processes data input from the data node DN to generate output data, and transfers the output data to another data node DN.

Table 11 shows an example of the attributes of the task node TN included in the data pipeline specification. The task node TN may have other attributes in addition to those present in Table 11.

TABLE 11

| Attributes of | | |
|---|---|---|
| task node TN | Definition | Example |
| Node name | Unique identifier of the task | |
| | node TN | |
| Inputs/outputs | The data node DN | |
| | referenced by the task. This | |
| | is divided into an input | |
| | attribute and an output | |
| | attribute. | |
| Command | Basic commands required | |
| | for task execution | |
| Arguments (abbreviated | Arguments transferred upon | |
| as args) | command execution | |
| Environment variables | Data path, credentials, and | |
| (abbreviated as env) | the like | |
| Resources | Resource requirements | Limits: upper limit of |
| | ※ Sub-attributes: Upper | resources such a CPU |
| | resource limit and basic | and a memory |
| | requirements (requests) | Requests: basic |
| | | requirements for the |
| | | CPU, the memory, and |
| | | the like |
| Dependencies | Task dependency. That is, | |
| | attributes defining an | |
| | execution order with other | |
| | task nodes TN | |
| Container image node | Reference to container | |
| (imageNode) or container | image node (imageNode: | |
| image (image) | CN). | |
| | Container image: scheme | |
| | for directly defining the | |
| | container image in the task, | |
| | unlike the above scheme | |
| | (imageNode) | |

Table 12 shows an example of a task node specification, constructed based on the attributes of the task node TN in Table 11. The task node specification is included in the data pipeline specification.

TABLE 12

```
tasks:
  - name: preprocess_data
    inputs: [raw_data]
    outputs: [processed_data]
    container:
      imageNode: preprocessor
      env:
        - name: INPUT_PATH
          value: “{{ dataNodes.raw_data.path }}”
        - name: OUTPUT_PATH
          value: “{{ dataNodes.processed_data.path }}”
      resources:
        limits:
          cpu: “2”
          memory: “1024Mi”
        requests:
          cpu: “1”
      memory: “512Mi”
    dependencies: [ ]
  - name: aggregate_data
    inputs: [processed_data, user_table]
    outputs: [aggregated_output_data]
    container:
      imageNode: aggregator
      env:
        - name: INPUT_01_PATH
          value: “{{ dataNodes.processed_data.path }}”
        - name: INPUT_02_PATH
          value: “{{ dataNodes.user_table.query }}”
        - name: OUTPUT_PATH
          value: “{{ dataNodes.aggregated_output_data.path }}”
      resources:
        limits:
          cpu: “2”
          memory: “1024Mi”
        requests:
          cpu: “1”
          memory: “512Mi”
    dependencies: [preprocess_data]
```

Meanwhile, Table 3 presents node combinations that may have data dependencies in the data pipeline specification according to the present invention. In the embodiment of the above-described data pipeline specification, a data dependency between the data node DN and the task node TN is defined as an input/output attribute of the task node TN, and the data dependency between the data node DN and the storage node SN is defined as a storage attribute of the data node DN. A data dependency between the task node TN and the container image node CN is defined as a container image attribute of the task node TN, and a data dependency between the container image node CN and the storage node SN is defined as a registry attribute of the container image node CN. Further, a task dependency between task nodes TN, which has been applied since the existing technology, is defined as a dependency attribute of the task node TN.

The data pipeline specification according to the present invention may be designed based on the data-centric DAG or represented as the data-centric DAG. The data-centric DAG defines relationships between the data node DN, the storage node SN, the container image node CN, and the task node TN, and is a structure that clearly represents the data dependency and the task dependency. In other words, the data-centric DAG is a structure that clearly represents a data flow. Unlike an existing task-centric structure that focuses on managing the execution order and parallelism of the tasks, the data-centric DAG proposed in the present invention is characterized by allowing tasks to be disposed and the storage and the data to be managed based on data flows.

Hereinafter, a relationship between the data node DN and another node among relationships between the nodes included in the specification will be described in connection with a data flow represented in a data pipeline specification based on the data-centric DAG.

First, a relationship between the data node DN and the storage node SN will be described. The data node DN is connected to the storage node SN to physically manage data. In the data pipeline specification, a data location and access scheme corresponding to the data node DN are defined through attributes such as the endpoint and bucket name of the storage node SN and a path of the data node DN.

Further, a relationship between the data node DN and the task node TN will be described. The task node TN refers to the input data node DN-In and the output data node DN-Out. The input data node DN-In and the output data node DN-Out are data nodes DN. The WMS 100 may automatically manage a task execution order through data dependency between the task node TN and the data node DN.

Meanwhile, in the data pipeline specification according to the present invention, an indirect relationship is formed between the storage node SN and the task node TN through the data node DN, and the task node TN interacts with the storage node SN through the data node DN.

Hereinafter, a scheme for operating the task node TN will be described.

The task node TN prepares for task execution based on a status and path of the data node DN referenced as the input/output attribute. For example, the task node TN monitors the status of the data node DN and executes the task when the status of the data node DN changes from pending to ready.

When a task is executed, the task node TN receives and processes data (input data) by referencing the input data node DN-In, which is the data node DN referenced as the input attribute. The task node TN stores data (output data) generated as a result of the processing in the output data node DN-Out, which is the data node DN referenced by the output attribute. When the output data is stored in the output data node DN-Out, a status of the output data node DN-Out is updated from pending to ready, and then another task node TN that receives the data from the output data node DN-Out can process the data by referencing the output data node DN-Out.

The manner of operating the task node TN according to an example of the data pipeline specification in Table 13 will be described.

TABLE 13

```
dataNodes:
  - name: raw_data
    storage: object_storage
    path: “raw/raw_data.csv”
    status: “ready”
    - name: processed_data
    storage: object_storage
    path: “processed/processed_data.csv”
    status: “pending”
tasks:
  - name: preprocess_data
    inputs: [raw_data]
    outputs: [processed_data]
    container:
    imageNode: preprocessor
    command: [“python3”]
    args: [“preprocess.py”]
```

The data pipeline specification in Table 13 presents the data preprocessing task node (TN1 in FIG. 2) as the task node TN. The data preprocessing task node TN1 uses the raw data node (DN1 in FIG. 2) as an input to process the data, and stores results of the processing in the “processed data node” (DN2 in FIG. 2).

A status of the node DN2 may be updated to ready after the task execution of the node TN1 is completed, and the node DN2 may then be referenced by the data aggregation task node TN2 in FIG. 2.

Hereinafter, the template scheme that the WMS 100 utilizes to reuse the data pipeline specification will be described.

The template scheme is a technology for minimizing repetitive input by dynamically referencing attribute information of the data node DN and attribute information of the storage node SN using a template engine (for example, a structure of Jinja2 that is a Python-based template engine).

The WMS 100 automatically generates information required for task execution, that is, the data pipeline (workflow), by applying a template variable constructed by attributes of the data nodes DN and the storage nodes SN to a previously stored data pipeline specification.

The WMS 100 may define the template variable by referencing some attributes (attributes of the nodes) included in the data pipeline specification. For example, the WMS 100 may define the template variable by referencing a path, status, or metadata which are attributes of the data node DN, and may also define the template variable by referencing an endpoint, bucket name, or credentials, which are attributes of the storage node SN. That is, the WMS 100 may include, in the template variable, at least one or a combination of the path, the status, and the metadata of the data node DN, and the endpoint, the bucket name, and the credentials of the storage node SN. In the present invention, the attributes included in the template variable are not limited to the examples described above.

The WMS 100 may update the attributes of the task node TN by utilizing the template variable. For example, the WMS 100 may dynamically input a value of the template variable to an environment variable env of the task node TN.

The WMS 100 may set the template variable by referencing the attributes of the data node DN and the storage node SN of the data pipeline specification before executing the data pipeline (may set a value of the template variable). When the task is executed, the WMS 100 inputs information defined as the template variable (for example, the path of the data node DN, the endpoint of the storage node SN, and the credentials) to the environment variable of the specific task node TN. Assuming that the information defined as the template variable is an attribute of the data node DN or the storage node SN, when only the data node specification or storage node specification of the data pipeline specification is modified, the WMS 100 may reuse the data pipeline by setting the template variable based on the modified data node specification and storage node specification and inputting the template variable to the environment variable of the task node TN. In other words, when the data pipeline specification is modified, the same template may be reused if only the attributes of the data node DN or the storage node SN is changed.

As described above, the WMS 100 may dynamically generate INPUT_PATH and OUTPUT_PATH of the container, which are attributes of the task node TN, using the template variable (see Table 12). In Table 12, a data preprocessing task preprocess_data sets “INPUT_PATH” as a template variable called “{{dataNodes.raw_data.path}}” rather than a specific file path. The WMS 100 dynamically interprets this template variable at the time of execution and replaces a value of INPUT_PATH with a path of a real file.

Since the WMS 100 references information on a raw data (raw_data) node DN1 and a processed data (processed_data) node DN2 among the data nodes DNs as the template variable, the same template may be reused in various environments. The value of the template variable is dynamically replaced at the time of execution. Therefore, when the data pipeline is executed for other data after the data pipeline specification has been developed, the WMS 100 may change the information on the raw data node raw_data DN1 and the processed data node processed_data DN2 in an existing data pipeline specification into other information (metadata). This is an advantage of defining the data pipeline specification using the template variable.

Table 14 shows an example in which the path of the data node DN, the endpoint of the storage node SN, and credentials are included in the template variable, and then the template variable is input to the environment variable of the task node TN.

```
TABLE 14
tasks:
  - name: preprocess_data
    container:
    image: {{ imageNodes.preprocessor.repository }}:{{ imageNodes.preprocessor.tag }}”
    env:
      - name: INPUT_DATA
        value: |
        {
          “endpoint”: “{{ storageNodes.object_storage.endpoint }}”,
          “access_key”: “{{ storageNodes.object_storage.credentials.access_key }}”,
          “path”: “{{ dataNodes.raw_data.path }}”
        }
```

As described above, the WMS 100 may reuse the same data pipeline specification in various environments simply by changing the data node DN and the storage node SN.

FIG. 3 is a flowchart illustrating a method of operating the WMS according to the embodiment of the present invention.

Referring to FIG. 3, the method of operating the WMS according to the embodiment of the present invention includes operations S210 to S230. The method illustrated in FIG. 3 is an embodiment, and the steps of the method of operating the WMS according to the present invention are not limited to the embodiment illustrated in FIG. 3 and may be added, modified, or deleted as needed.

Operation S210 is an operation for receiving the data pipeline specification.

Operation S210 is an operation for receiving a request to execute the data pipeline. Specifically, the communication device 120 or the input interface device 150 of the WMS 100 receives a data pipeline name and the data pipeline specification from a user or an external server and stores the data pipeline specification in the memory 130 or the storage device 140. The data pipeline specification is defined based on the data-centric DAG. The processor 110 of the WMS 100 reads the data pipeline specification stored in the memory 130 or the storage device 140.

Details of the data pipeline specification have been described above with reference to FIGS. 1 and 2.

Operation S220 is an operation of creating the data pipeline.

The processor 110 creates the data pipeline according to the input data pipeline specification and assigns a unique identifier (ID) to the created data pipeline.

Operation S230 is an operation of executing the data pipeline.

The processor 110 executes the created data pipeline. The processor 110 checks whether the execution of the data pipeline has been successfully initiated and transmits a result of the data pipeline execution to the external server or a user terminal managed by the user via the communication device 120 or the output interface device 160.

The method of operating the WMS described above has been described with reference to the flowchart presented in the drawings. For simplicity of the description, the method has been illustrated and described as a series of blocks, but the present invention is not limited to the order of the blocks, some blocks may occur in a different order from those illustrated and described herein or simultaneously with other blocks, and various other branches, flow paths, and block orders that achieve the same or similar results may be implemented. Further, not all illustrated blocks may be required to implement the method described herein.

Meanwhile, in the descriptions with reference to FIG. 3, respective operations may be further divided into additional operations or combined into fewer operations according to the implementation of the present invention. Further, some operations may be omitted as needed. In addition, even when other content is omitted, the content of FIGS. 1 and 2 and Tables 3 to 14 and the content described with reference to the drawing and tables may be applied to the content of FIG. 3. Further, the content of FIG. 3 may be applied to other parts of the description of the invention.

The effects of the present invention are as follows:

### 1. Increased Transparency and Efficiency of Data Management

It is possible to transparently define a data flow by explicitly managing a status, location, format, and metadata of data through data nodes. It is also possible to enhance the efficiency of data management by centrally controlling dependencies between data and a relationship between storages.

### 2. Minimization of Duplicate Input and Simplification of Specifications

It is possible to eliminate repetitive input by introducing the template scheme and dynamically reference the data and the storage information. It is also possible to reuse the same workflow specification in various environments by simply changing only the data node and the storage node. Further, according to the present invention, it is possible to reuse the same image in several tasks and facilitate build information and version tracking by introducing the container image node. Tasks and images are separated, which improves the maintainability of the workflow specification and provides the efficiency of management even in large-scale environments.

### 3. Clarifying Relationship Between Task and Data

A dependency between the task and the data is clearly represented through data-centric design, enabling conditional execution and error processing based on data status.

### 4. Optimizing Large-Scale Data Pipeline Management

Data movement, version management, and state tracking are automated through storage nodes, which reduces the complexity of managing large-scale data workflows. Further, parallel processing and workflow expansion can be easily performed.

### 5. Ensuring Versatility of Workflow Specification

Since a specification is created in a JSON or YAML format, the specification is not dependent on a specific workflow engine (such as Argo Workflows or Apache Airflow) and can be reused in various systems. Further, it is possible to improve maintainability by minimizing a range of specification modification depending on an execution environment using the template scheme.

The effects of the present invention are not limited to those described above, and other effects that are not mentioned will be clearly understood by those skilled in the art from the above description.

While the present invention has been described above with reference to preferred embodiments, it will be understood by those skilled in the art that various modifications and variations may be made to the present invention without departing from the spirit and scope of the present invention as set forth in the claims below.

What is claimed is:

1. A workflow management system comprising:
a memory configured to store computer-readable instructions; and
at least one processor configured to execute the instructions,
wherein the at least one processor is configured to execute the instructions to
read a data pipeline specification defined based on a data-centric directed acyclic graph (DAG),
create a data pipeline according to the data pipeline specification, and
execute the data pipeline.

2. The workflow management system of claim 1,
wherein the data pipeline specification includes a data node specification and a task node specification, and
a data dependency between the data node and the task node is defined based on the data node specification and the task node specification.

3. The workflow management system of claim 1,
wherein the data pipeline specification includes a data node specification, and
the data node specification defines a location and status of data nodes constituting the data pipeline.

4. The workflow management system of claim 1,
wherein the data pipeline specification includes a storage node specification, and
the storage node specification defines a type, endpoint, and credentials of storage nodes constituting the data pipeline.

5. The workflow management system of claim 1,
wherein the data pipeline specification includes a data node specification, a storage node specification, and a task node specification, and
the at least one processor is configured to, in a process of generating the data pipeline, set a template variable based on location information of each data node extracted from the data node specification and an endpoint and credentials of each storage node extracted from the storage node specification, and input the template variable to an environment variable of the task node specification.

6. A method of operating a workflow management system, comprising:
receiving a data pipeline specification defined based on a data-centric directed acyclic graph (DAG);
creating a data pipeline based on the data pipeline specification; and
executing the data pipeline.

7. The method of claim 6,
wherein the data pipeline specification includes a data node specification and a task node specification, and
a data dependency between the data node and the task node is defined based on the data node specification and the task node specification.

8. The method of claim 6,
wherein the data pipeline specification includes a data node specification, and
the data node specification defines a location and status of data nodes constituting the data pipeline.

9. The method of claim 6,
wherein the data pipeline specification includes a storage node specification, and
the storage node specification defines a type, endpoint, and credentials of storage nodes constituting the data pipeline.

10. The method of claim 6,
wherein the data pipeline specification includes a data node specification, a storage node specification, and a task node specification, and
the generating of the data pipeline includes setting, by the workflow management system, a template variable based on location information of each data node extracted from the data node specification and an endpoint and credentials of each storage node extracted from the storage node specification, and inputting the template variable to an environment variable of the task node specification.
